(19) United States
(12) Patent Application Publication
(10) Pub. No.: US 2007/0102037 A1
(43) Pub. Date: May 10, 2007

(54) Self-powered systems and methods using auxiliary solar cells

(76) Inventor: Philip C. Irwin, Sierra Madre, CA (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/543,268

(22) Filed: Oct. 4, 2006

Related U.S. Application Data
(60) Provisional application No. 60/723,589, filed on Oct. 4, 2005.

(51) Int. Cl. H02N 6/00

(52) U.S. Cl. 136/246

(57) ABSTRACT

The present invention relates to technology for providing independent electrical power to a wide variety of electronic and/or mechanical systems, especially systems incorporating sensors and corresponding components that are used to take action based upon sensed information.

### PRIORITY CLAIM

The present non-provisional patent Application claims priority under 35 USC § 119(e) from United States Provisional Patent Application having Ser. No. 60/723,589, filed on Oct. 4, 2005, and titled SELF-POWERED SYSTEMS AND METHODS USING AUXILIARY SOLAR CELLS, wherein the entirety of said provisional patent application is incorporated herein by reference.

### FIELD OF THE INVENTION

The present invention relates to technology for providing independent electrical power to a wide variety of electronic and/or mechanical systems, especially systems incorporating sensors and corresponding components that are used to take action based upon sensed information.

### BACKGROUND OF THE INVENTION

Photovoltaic systems convert incident light, often sunlight, into electrical power. One class of photovoltaic systems involves the use of photovoltaic concentrator modules. A photovoltaic concentrator module includes optics that collect incident light and then directs it to a central point including a photovoltaic element. The photovoltaic element converts the concentrated light into electricity. A typical photovoltaic system based upon the concentrator module concept generally incorporates an array of photovoltaic concentrator modules.

Photovoltaic systems incorporating the photovoltaic concentrator module concept have been described in U.S. Pat. Nos. 4,968,355; 4,000,734; and 4,296,731; U.S. Pat. Publication Nos. 2005/0034751; 2003/0075212; 2005/0081908; and 2003/0201007; and in Assignee's U.S. Provisional Patent Application No. 60/691,319, filed Jun. 16, 2005 in the name of Hines, titled PLANAR CONCENTRATING PHOTOVOLTAIC SOLAR PANEL WITH INDIVIDUALLY ARTICULATING CONCENTRATOR ELEMENTS.

All of such patents, published applications, and application are incorporated herein by reference in their respective entireties for all purposes.

Photovoltaic systems incorporating photovoltaic concentrator module(s) typically are mounted outside in locations at which the module(s) can capture incident sunlight throughout as much of the available daylight hours as practically feasible. In order to maximize the intensity of the captured sunlight, and thereby maximize power output, the photovoltaic concentrator modules typically are articulated so as to track or follow the sun. Accordingly, these systems incorporate automated tracking systems.

A typical tracking system generally incorporates one or more sensors, a tracking control system, and actuating components. The sensor(s) are used to sense the sun position. The tracking control system uses the sensed information to determine how to position the solar concentrator(s). The tracking control system then outputs appropriate signals to cause the actuating components to position the photovoltaic concentrator module(s) in the desired manner.

Most such tracking systems need electrical power to operate. In addition to tracking operations, other photovoltaic power system operations generally utilize electric power to function. These include automated system controls and monitoring functions, telemetry, time estimation, system security, system health monitoring, combinations of these, and/or the like. To date, most commercially available photovoltaic power systems either use a separate grid-connected power supply and/or attempt to extract power needed from system-generated power.

Conventional tracking systems are known that use separate auxiliary solar panels for power, such as in U.S. Pat. No. 4,556,788. The system in this patent uses the shading of the cells of a solar panel to run a DC motor. The cells are wired in such a way that if the sun is centered on the cell array, the motor does not actuate tracking actions. When the sun moves off-center, the motor actuates movement to compensate.

An example of a self-powered tracking system that employs gas-filled canisters and does not require electric power is described in U.S. Pat. No. 4,476,854.

### SUMMARY OF THE INVENTION

The present invention relates to technology for providing independent electrical power to a wide variety of electronic and/or mechanical systems, especially electronic systems incorporating sensors and corresponding components that are used to take action based upon sensed information.

The present invention is particularly useful for providing independent electrical power to photovoltaic power systems to help power one or more system operations without the need to rely upon an external power grid or the need to draw power from system generated power. The present invention may provide electric power to a wide variety of operations of a photovoltaic power system, including sun tracking and corresponding component actuation, telemetry, time estimation, and/or the like.

In representative embodiments, the present invention provides self-powered tracking systems and associated drive mechanisms for one or more photovoltaic concentrator modules, wherein the tracking systems have a method of sensing the location of the sun and also components responsive to sensed information to affect the position of the concentrator module(s) to point at the sun. Resultant, self-powered tracking systems are preferably used in combination with arrays of photovoltaic concentrator modules.

The present invention can provide self powering-based solutions for photovoltaic systems in the course of generating electric power, e.g., functions performed by automated tracking systems. In short, the approach of the invention can offer simple and safe technology for providing independent electrical power.

Advantageously, an external power supply and/or drawing from generated power may still be used in the practice of the invention, but neither is needed. In the preferred embodiment of the present invention, solar cells may be arranged on the perimeter of the photovoltaic power system, and the electric current generated by these cells is used to power desired operations, e.g. the automated tracking functions that include tracking electronics that read sun position information from a sensor and the drive mechanisms that then effect change in the pointing angle of the photovoltaic concentrator module(s). Various embodiments of the present invention have one or more of the following favorable characteristics: 1) Simple in nature: Photovoltaic solar cells are readily available with various physical dimensions and can be easily wired in series/parallel combinations to achieve any reasonable voltage/current combination; 2) Non-Specific: The photovoltaic solar cells used to self-power system functions are independent of the tracking sensor(s) and tracking actuator(s) that are used, therefore coupling between these elements is not necessarily required; 3) Compatible: A wide range of electronic tracking electronics and components can be used. Preferably the electric power used by the driving motors does not exceed that available from the solar cells. Accuracy tends to be limited in many embodiments only by the tracking sensor and/or actuator chosen; 4) Reliable power output independent of orientation: The photovoltaic cells may be tilted and positioned at multiple locations around the system in order to ensure sufficient electric power as the sun moves during the day and regardless of the physical orientation of the system as installed; and 5) Balanced power throughout the day: The photovoltaic cells may be tilted in a manner to help aid in the uniformity of the power produced throughout the day. For instance, with respect to the preferred embodiment shown in FIG. 1, in the morning, the east-facing cells can produce more power than the west-facing cells. At noon, both sets of cells can produce an equal amount of power, but not necessarily at their respective maxima.

The preferred embodiment of the present invention can operate with an array of individually articulating photovoltaic concentrator modules, preferably as described in Assignee's U.S. Provisional Patent Application No. 60/691,319, filed Jun. 16, 2005 in the name of Hines, titled PLANAR CONCENTRATING PHOTOVOLTAIC SOLAR PANEL WITH INDIVIDUALLY ARTICULATING CONCENTRATOR ELEMENTS, wherein the entirety of said provisional patent application is incorporated herein by reference for all purposes.

The present invention can offer many additional advantages, singly or in combination among the various embodiments. If desired, system functions, e.g., the functions associated with the tracking system, may be powered without the use of external power and/or without extracting power from a photovoltaic concentrator module itself.

According to one aspect of the present invention, a photovoltaic power system includes a component that articulates and tracks the sun and a source of electrical power. The source of electrical power includes a first, fixed photovoltaic solar cell and a second, fixed, photovoltaic solar cell. The first cell has a face oriented in a first direction and the second cell has a face oriented in a second direction. The second direction is different from the first direction. The source of electrical power is electrically coupled to the component in a manner effective such that light that is incident upon one or more of the faces is converted into an electrical output used to provide power to articulate the component.

According to another aspect of the present invention, a photovoltaic power system includes an articulating, photovoltaic concentrator module and a plurality of fixed, photovoltaic cells. The module is supported upon a frame and provides an electrical power output from the system. The cells are coupled to the system in a manner effective to provide electrical power internally to one or more components of the power system. The cells are positioned at a plurality of locations and are oriented in a plurality of directions in a manner effective to capture incident sunlight as the sun moves.

According to another aspect of the present invention, a method of providing electrical power to a system includes the steps of providing a plurality of fixed solar cells that convert incident sunlight into electrical power, causing the fixed solar cells to be electrically coupled to at least one component of the system that uses electrical power, and causing the electrical component to use the electrical power provided by the cells. The cells are mounted on the system and oriented in a plurality of directions to capture incident sunlight as the sun moves.

According to another aspect of the present invention, a method of providing electrical power includes the steps of causing a plurality of fixed solar cells to provide electrical power for internal use by a photovoltaic power system and causing a plurality of articulating solar cells of the power system to provide electrical power for a use external to the system. The cells are oriented in a plurality of directions to capture incident sunlight as the sun moves. The cells are affixed to the photovoltaic power system.

According to another aspect of the present invention, a photovoltaic power system includes a photovoltaic cell provided on a fixed wedge. The photovoltaic cell is electrically coupled to an articulating component of the photovoltaic power system.

According to another aspect of the present invention, a photovoltaic power system includes a plurality of individually moveable photovoltaic concentrator modules or module groups, a self-powered tracking system, at least one sensor, actuating componentry, and a control system. Each module includes at least one photovoltaic cell physically coupled to the module and a solar concentrator that helps to concentrate incident light upon at least one corresponding photovoltaic cell. The self-powered tracking system is electrically coupled to the photovoltaic power system. The self-powered tracking system includes one or more fixed and tilted photovoltaic cells that capture incident light and convert it to an electrical power output. The self-powered tracking system photovoltaic cells are separate from the photovoltaic cells of the concentrator modules. The at least one sensor uses the electrical power output to generate information indicative of a sensed position of a light source. The actuating componentry uses the electrical power output to move the photovoltaic concentrator modules in a range of motion including one or more desired photovoltaic concentrator module positions. The control system uses the electrical power output and the sensed information to cause the actuating componentry to move the photovoltaic concentrator modules to one or more desired positions.

According to another aspect of the present invention, a system includes at least one sub-system that performs one or more functions using electrical power. The sub-system is electrically coupled to at least one fixed, tilted photovoltaic cell string, wherein the cell string comprises at least one photovoltaic cell.

### BRIEF DESCRIPTION OF THE DRAWINGS

FIG. 1 shows a schematic, perspective view of an embodiment of a photovoltaic power system according to the present invention, including self-powering solar cells attached to the frame of the unit.

FIG. 2 shows a schematic, perspective view of a cell string used in the photovoltaic power system of FIG. 1.

FIG. 3 shows a geometric diagram that illustrates the calculation for the preferred tilt angle of the cell string illustrated in FIG. 2.

FIG. 4 shows a block wiring diagram of the self-powering circuit for the photovoltaic power system illustrated in FIG. 1.

FIG. 5 shows an alternative schematic diagram of a single string of self-powering cells.

FIGS. 6-11 each show an additional alternative schematic diagram of a single string of self-powering cells including bypass diodes.

FIG. 12 shows a schematic diagram of a power conditioning circuit for use with a photovoltaic power system according to the present invention.

### DETAILED DESCRIPTION OF PREFERRED EMBODIMENT

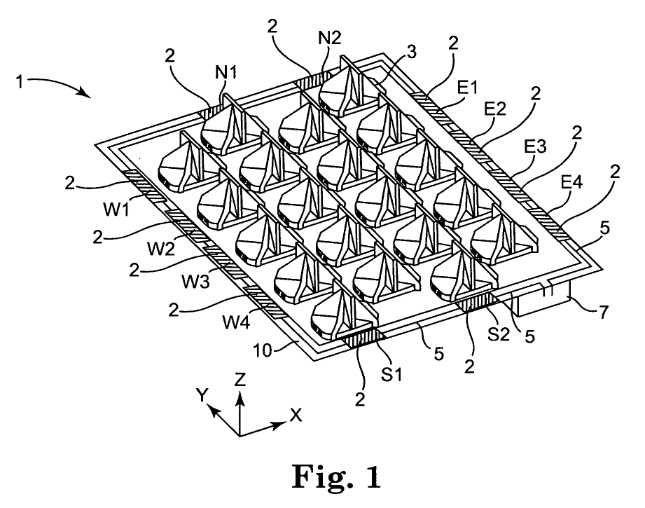

The principles of the present invention may be used to provide self-power for a wide variety of operations associated with electronic and mechanical systems (e.g., a self-powered tracking system, a self-powered telemetry system, a self-powered control system, a security system, a self-powered time estimation system, or the like). For purposes of illustration, the present invention will now be described in the context of a photovoltaic power system incorporating a self-powered tracking system. As shown in FIG. 1, photovoltaic power system 1 includes a support frame 10, twenty photovoltaic concentrator modules 3, twelve photovoltaic cell strings 2, wiring 5, and electronics box 7. FIG. 1 is a high-level diagram of the preferred embodiment of the present invention used in combination with an array of photovoltaic concentrator modules 3.

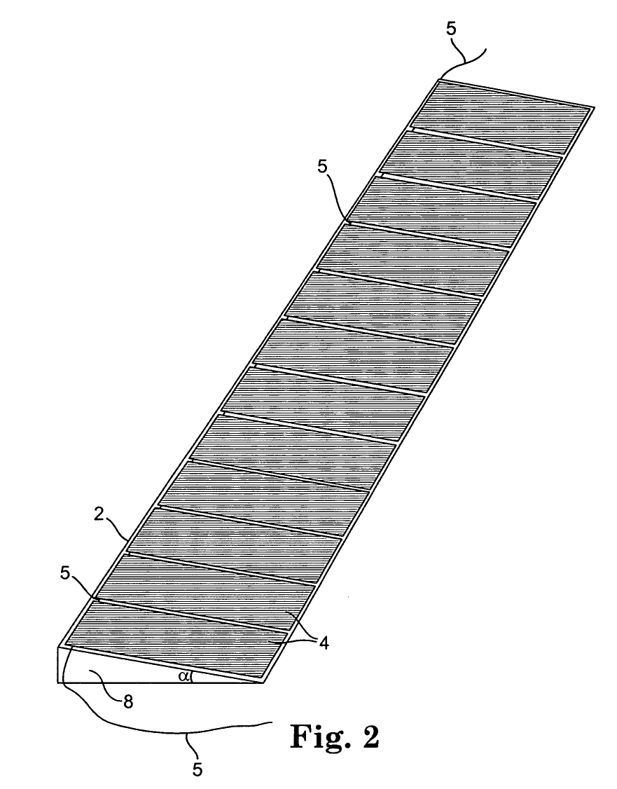

The preferred modules and array are described in Assignee's U.S. Provisional Patent Application No. 60/691,319, filed Jun. 16, 2005 in the name of Hines, titled PLANAR CONCENTRATING PHOTOVOLTAIC SOLAR PANEL WITH INDIVIDUALLY ARTICULATING CONCENTRATOR ELEMENTS. FIGS. 2a and 2b of this provisional application show the preferred modules 3 in more detail.

A photovoltaic cell that is used to generate independent, self-powered operations may be conveniently placed anywhere on the associated power system suitable for capturing incident light (e.g., from a light source such as the sun), including one or more of the frame, base, rail, or other fixtures of a photovoltaic power system or on one or more of its photovoltaic concentrator modules.

As shown in FIG. 1, a major purpose of the support frame 1 is mechanical support of one or more photovoltaic concentrator modules 3, but the frame 1 is also used to mount the self-powering photovoltaic cells 2. The cells 2 are preferably wired together in a series/parallel combination with wires 5 running along the frame. These wires 5 then preferably terminate in a single pair at an electronics box 7.

FIG. 1 includes three-dimensional axes that are identified by the three arrows in the lower left corner of FIG. 1, with positive being in the directions of the arrows. The present invention is tolerant to orientation changes with respect to compass heading. The preferred orientation, however, is noted by the letter/number references with respect to each of the strings 2. For instance, the letter/number references S1, W1, N1, and E1 denote southerly, westerly, northerly, and easterly, respectively. +X is preferably East, +Y is preferably North. This orientation is preferred because the long axis of the panel then presents itself to the East and West, providing for more uniform power output throughout the day.

FIG. 2 is a diagram of a string 2 of photovoltaic cells 4. The preferred embodiment of the present invention comprises twelve photovoltaic cells 4 per string 2. Typical silicon photovoltaic cells can produce an average voltage of approximately 0.5V. Accordingly, twelve such cells 4 in series can produce a voltage of approximately 6V, which is a convenient voltage. Such a string 2 can be further combined with more strings 2 to produce 12V, 18V, or 24V. Such voltages are common voltages for running stepper and DC motors. More or fewer cells 4 could be used per string, as an option.

Multiple strings 2 of cells 4 fixed and tilted in multiple directions may be used so that a moderately uniform power output is maintained as the sun moves throughout the day. The photovoltaic cells 4, being tilted in different directions or otherwise arranged, can produce reliable and significant levels of minimum power throughout the day, regardless of the physical orientation of the concentrator.

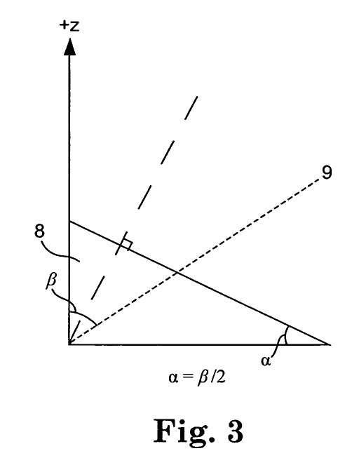

As shown in, for example, FIG. 2, each string 2 of cells 4 is preferably mounted on a wedge 8, preferably so that the faces of the cells 4 are oriented outward rather than inward toward the modules 3. The angle α of the wedge 8 is preferably the half angle of the maximum articulation angle β of the photovoltaic concentrator modules 3, as shown in FIG. 3. If the photovoltaic concentrator modules 3 can point all the way to the horizon, angle β would be 90°, so the preferred tilt angle α of the wedge 8 would be 45°. This tilt angle α can provide for the most uniform auxiliary power throughout the day. As the sun moves across the sky, different strings 2 will typically be producing different amounts of power depending on the relative angle between the face of a cell 4 and the incident sunlight 9. In general, while a cell 4 can produce its maximum power when the incident light is normal (90°) to the face of the cell 4, the orientations of cells 4 are preferably determined for uniformity of power output throughout the day rather than for maximum power output at a particular point of the day, as is done more conventionally. Tilting the cells 4 on each rail in outward, multiple directions can provide for a more uniform power output throughout the day.

Strings 2 of cells 4 may be connected in series/parallel combinations, sufficient to power tracking control electronics and actuators for photovoltaic power system 1.

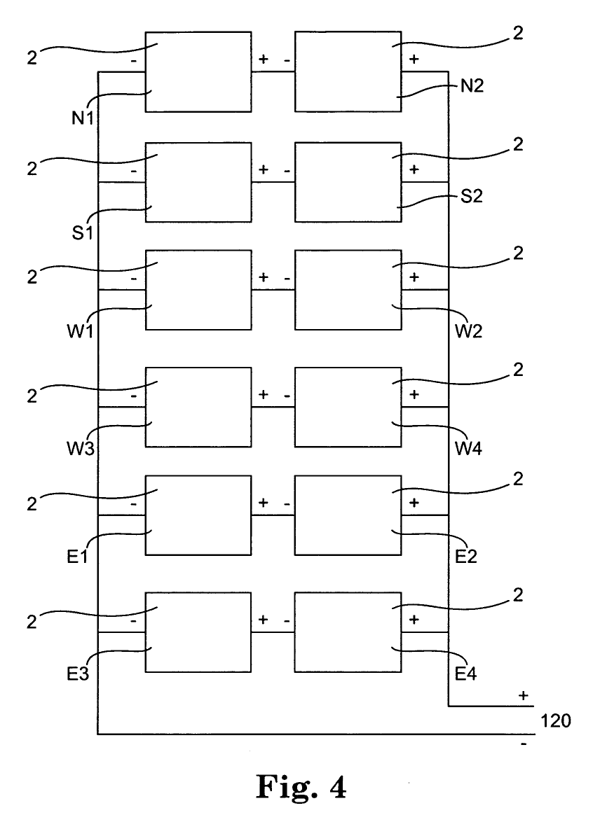

The preferred embodiment of the present invention comprises twelve strings 2, in a series/parallel combination shown in FIG. 4. As shown, a plurality of strings 2 that are associated with a particular direction, e.g., easterly or the like, are connected in series. Thus, the E1 and E2 strings 2 are connected in series to form a series string group. Additionally, the various string 2 groups are also connected in parallel with respect to each other. Series connections tend to increase the output voltage of the combination, while parallel connections tend to increase the output current of the combination. Although twelve strings 2 are shown in FIG. 4 arranged around the frame 10, the total system 1 and each side of the frame 10 can have any number of strings 2, connected in various series/parallel combinations.

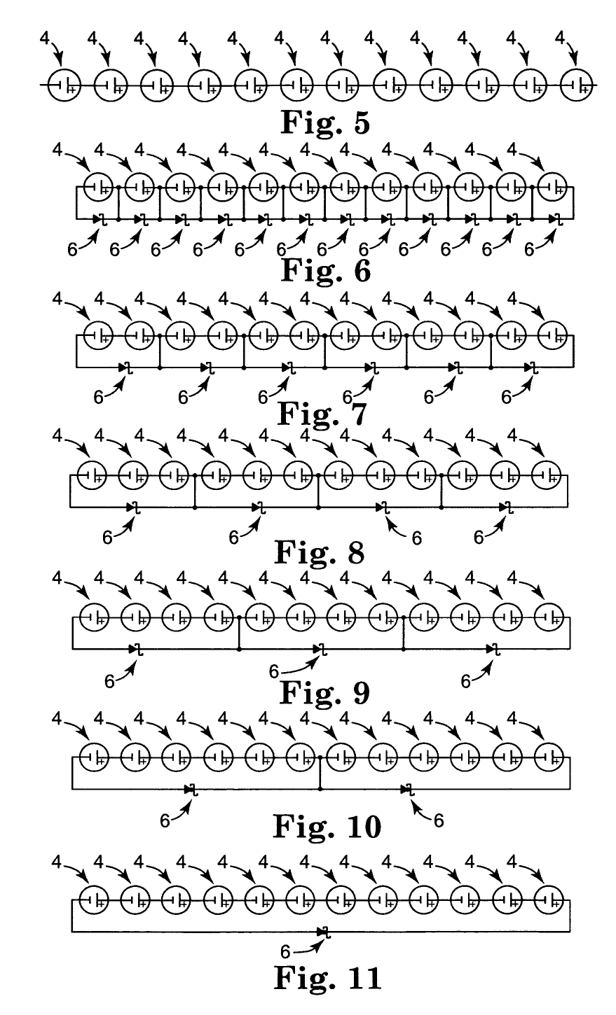

A schematic diagram of a string 2 of individual, self-powering photovoltaic cells 4 is shown in FIG. 5. This is what a string 2 of cells 4 looks like without bypass circuitry including, for instance, bypass diodes 6.

By-pass circuits, e.g., circuits incorporating bypass diodes, may be associated with individual cells 4 or cell groups in order to mitigate the effects of shading that may be present on the output power of the self-powering system.

Schematics of preferred cell 4 strings 2 including one or more of bypass diodes 6 are shown in FIGS. 6-11. One or more bypass diodes 6 can allow parts of the string 2 to become shaded without losing the power from the entire string 2. In general, without one or more bypass diodes 6, when a portion of the string 2 is shaded the current in the entire string will drop to the current provided by the shaded cell 4, which is often on the order of 10% of that under full sun. One or more bypass diodes 6 can allow the current to flow around the shaded cell (or series of cells), reducing the overall power generated by the cells 4, but only by the amount that the bypassed cell 4 (or string 2 of cells 4) would provide.

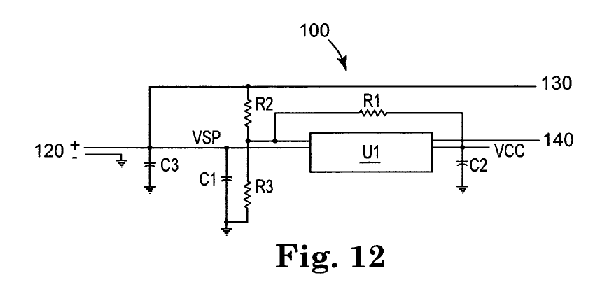

Two or more bypass diodes 6 can be conveniently added around every cell 4 or every two, three, four, or six cells 4 within the string 2 as shown in FIGS. 7-10, respectively. It can even be helpful to put a diode 6 around the entire string, as shown in FIG. 11. In the configuration shown in FIG. 11, in the event of shading, one entire string 2 would be ineffectual, but if another string 2 is placed in series with it, e.g. as shown in FIG. 4, one string 2 will still provide its full available power. Schottky diodes are preferred because of their extremely low forward voltage.

FIG. 12 shows a schematic diagram of a possible power conditioning circuit 100 for use with a photovoltaic power system 1 according to the present invention. As shown in FIG. 12, circuit 100 can be in electric communication with self-powering photovoltaic cells 4, as shown by point 120, in electric communication with a motor (deliver motor power), as shown by point 130, an in electric communication with a microcontroller, as shown by point 140.

A self-powered operations may use a large capacitor or other energy storage device to facilitate the storing of power, together with a scheme wherein the tracking actuators or any other system components may be operated intermittently, rather than continuously, thereby reducing the number of photovoltaic cells 4 required. For example, the preferred embodiment of the present invention provides measures to handle variations in power due to transient shading (e.g., birds flying by, airplanes flying over, transient cloud cover, or people walking around the panel). A large capacitor may optionally be placed on the output of the self-powering system to store energy and slowly release it back into the tracking system. This capacitor is shown as C3 in FIG. 12. An exemplary capacitor C3 can be 2200 microfarads in size.

A self-powered system, e.g., a tracking system, may use an intelligent voltage regulator U1 in order to alert that the voltage, and therefore the power, is decreasing to a level at which the affected system may not be able to sustain operation. For example, if the tracking system used is controlled by a microprocessor, a special voltage regulator U1 may be employed to signal the microprocessor that the voltage is dropping below a specified level, so the microprocessor may execute a graceful shutdown. One such regulator is shown in FIG. 12 as regulator U1. In general, regulator U1 includes a shutdown input and an error output. An exemplary regulator U1 includes the LP2957 regulator manufactured by National Semiconductor, Santa Clara, Calif.

In the circuit 100 of FIG. 12, C1 and C2 reduce the amount of ripple on the power from the solar panels where VSP denotes the voltage generated by the solar panels and VCC denotes the regulated output voltage to the microprocessor. C1 reduces the voltage ripple of VSP from the panels into the regulator U1, and C2 reduces the voltage ripple of VCC into the control electronics indicated by point 140. An exemplary capacitor C1 can be 1 microfarad in size and an exemplary capacitor C2 can be 2 microfarads in size.

The resistor triplet R1, R2, R3 defines the turn-on/shutdown voltage for the regulator U1. The value of R3 is typically 47K-ohms. R1 and R2 can then be calculated based on the safe operating characteristics of the control electronics. R1 and R2 can be calculated by the following equations:
R1=(R3*(V_{off}+3.07*Vₒₙ−5))/(Vₒₙ−V_{off}) and
R2=((R1*R3)*(Vₒₙ−1.23))/(1.23*(R1+R3)),
assuming a 5V regulator output, where Vₒₙ is the desired turn-on voltage, and V_{off} is the desired shutdown voltage.

What is claimed is:

1. A photovoltaic power system, comprising:
a) a component that articulates and tracks the sun; and
b) a source of electrical power comprising:
1) a first, fixed photovoltaic solar cell having a face oriented in a first direction;
2) a second, fixed, photovoltaic solar cell having a face oriented in a second direction, wherein the second direction is different from the first direction;
wherein the source of electrical power is electrically coupled to the component in a manner effective such that light that is incident upon one or more of said faces is converted into an electrical output used to provide power to articulate the component.

2. The system of claim 1, wherein the first and second solar cells are fixed to a stationary frame, said frame further supporting a photovoltaic concentrator module that articulates to track the sun, wherein the first and second solar cells provide a source of electrical energy that powers articulation of the photovoltaic concentrator module.

3. The system of claim 1, wherein the first solar cell constitutes a cell in a first string of solar cells having respective faces oriented in the first direction, and wherein the second solar cell constitutes a cell in a second string of solar cells have respective faces oriented in the second direction.

4. The system of claim 3, wherein the solar cells of the first string are electrically coupled in a first series and the solar cells of the second string are electrically coupled in a second series, said first and second series being electrically coupled in parallel.

5. The system of claim 3, wherein a bypass diode is electrically coupled in parallel to at least one solar cell of the first string in a manner effective to help maintain a power output when said at least one solar cell of the first string is shaded.

6. The system of claim 3, wherein each cell of the first string is associated with a corresponding bypass diode.

7. The system of claim 3, wherein a group of cells of the first string is associated with a corresponding bypass diode.

8. The system of claim 3, wherein at least one solar cell of the first string is electrically coupled to the first string in a manner effective to help maintain a power output when said at least one solar cell of the first string is shaded.

9. The system of claim 3, wherein the first and second strings are fixed to a generally planar, fixed frame with faces oriented outward to capture incident sunlight.

10. The system of claim 8, wherein the first string is supported upon a wedge in a manner to orient the string outward from the frame.

11. A photovoltaic power system comprising:
a) an articulating, photovoltaic concentrator module supported upon a frame, said module providing an electrical power output from the system; and
b) a plurality of fixed, photovoltaic cells coupled to the system in a manner effective to provide electrical power internally to one or more components of the power system, said cells being positioned at a plurality of locations and being oriented in a plurality of directions in a manner effective to capture incident sunlight as the sun moves.

12. The system of claim 11, wherein the frame is fixed and the cells are affixed to the frame.

13. The system of claim 11, wherein the frame is rectilinear and has a long axis, and wherein the frame is installed so that the long axis presents itself to the east and west.

14. The system of claim 12, wherein a cell affixed to the frame has a face that is tilted with respect to the frame.

15. The system of claim 11, wherein a first solar cell constitutes a cell in a first string of solar cells having respective faces oriented in a first direction, and wherein a second solar cell constitutes a cell in a second string of solar cells have respective faces oriented in a second direction.

16. The system of claim 15, wherein the system comprises at least four strings of solar cells, wherein said strings have faces tilted toward the east, west, south, and north, respectively.

17. The system of claim 15, wherein the cells of the first string are electrically coupled in series, the cells of the second string are electrically coupled in series, and the first and second strings are electrically coupled in parallel.

18. The system of claim 15, wherein a bypass diode is electrically coupled in parallel to at least one solar cell of the first string in a manner effective to help maintain a power output when said at least one solar cell of the first string is shaded.

19. The system of claim 18, wherein each cell of the first string is associated with a corresponding bypass diode.

20. The system of claim 18, wherein a group of cells of the first string is associated with a corresponding bypass diode.

21. The system of claim 15, wherein at least one solar cell of the first string is electrically coupled to the first string in a manner effective to help maintain a power output when said at least one solar cell of the first string is shaded.

22. A method of providing electrical power to a system, comprising the steps of:
a) providing a plurality of fixed solar cells mounted on the system and oriented in a plurality of directions to capture incident sunlight as the sun moves, said cells converting the incident sunlight into electrical power;
b) causing the fixed solar cells to be electrically coupled to at least one component of the system that uses electrical power; and
c) causing the electrical component to use the electrical power provided by the fixed cells.

23. The method of claim 22, wherein the electrical component uses the electrical power to articulate a solar concentrator module supported upon a fixed frame.

24. The method of claim 22, wherein the electrical component comprises a sensor and the component uses the electrical power to sense the direction of incident sunlight and the system uses the sensed information to cause a solar concentrator module to articulate and track the sun.

25. A method of providing electrical power, comprising the steps of:
a) causing a plurality of fixed solar cells affixed to a photovoltaic power system to provide electrical power for internal use by the photovoltaic power system, said fixed solar cells being oriented in a plurality of directions to capture incident sunlight as the sun moves; and
b) causing a plurality of articulating solar cells of the power system to provide electrical power for a use external to the system.

26. A photovoltaic power system comprising a photovoltaic cell provided on a fixed wedge, wherein the photovoltaic cell is electrically coupled to an articulating component of the photovoltaic power system.

27. A photovoltaic power system, comprising:
a) a plurality of individually moveable photovoltaic concentrator modules or module groups, wherein each concentrator module of the plurality includes:
i) at least one photovoltaic cell physically coupled to the module; and
ii) a solar concentrator that helps to concentrate incident light upon at least one corresponding photovoltaic cell;
b) a self-powered tracking system being electrically coupled the photovoltaic power system, wherein the self-powered tracking system comprises one or more fixed and tilted photovoltaic cells that capture incident light and convert it to an electrical power output, wherein the self-powered tracking system photovoltaic cells are separate from the photovoltaic cells of the concentrator modules;
c) at least one sensor that uses the electrical power output to generate information indicative of a sensed position of a light source;
d) actuating componentry that uses the electrical power output to move the photovoltaic concentrator modules in a range of motion including one or more desired photovoltaic concentrator module positions; and
e) a control system that uses the electrical power output and the sensed information to cause the actuating componentry to move the photovoltaic concentrator modules to one or more desired positions.

28. A system comprising at least one sub-system that performs one or more functions using electrical power, said sub-system being electrically coupled to at least one fixed, tilted photovoltaic cell string, wherein the cell string comprises at least one photovoltaic cell.

29. The system of claim 28, wherein the one or more functions are selected from the group consisting of: a self-powered tracking system, a self-powered telemetry system, a self-powered control system, a security system, a self-powered time estimation system, and combinations thereof.
